(19) United States
(12) Patent Application Publication
(10) Pub. No.: US 2026/0163605 A1
(43) Pub. Date: Jun. 11, 2026

(54) RF CANCELLER SELF-INTERFERENCE CANCELLATION AND COMMUNICATION DEVICE INCLUDING THE SAME

(71) Applicant: UIF (University Industry Foundation), Yonsei University, Seoul (KR)

(72) Inventors: Byung-Wook MIN, Seoul (KR); Gisung YANG, Siheung-si (KR)

(21) Appl. No.: 19/409,270

(22) Filed: Dec. 4, 2025

(30) Foreign Application Priority Data
Dec. 5, 2024 (KR) 10-2024-0179944

(51) Int. Cl. H04B 1/525

(52) U.S. Cl. CPC H04B 1/525

(57) ABSTRACT

An RF canceller and a communication device including the same comprise: a distribution delay circuit configured to receive a divided transmission signal and redistribute it to generate a plurality of distribution signals having fixed delay time differences; a plurality of tap circuits configured to receive one of the plurality of distribution signals and to adjust a phase thereof to generate tap signals; a combining circuit configured to merge the plurality of tap signals to obtain a combined tap signal; and a group delay unit configured to receive the combined tap signal and to apply group delay thereto to generate a modeled self-interference signal. Commonly delaying the tap signals from the plurality of tap circuits suppresses the influence caused by mutual interference among the tap signals, simplifying the configuration of the tap circuits and enabling generation of a modeled self-interference signal closely resembling a passively suppressed residual self-interference signal.

### CROSS-REFERENCE TO RELATED APPLICATIONS

This application claims priority under 35 U.S.C. § 119(a) to Korean Patent Application No. 10-2024-0179944, filed on Dec. 5, 2024, with the Korean Intellectual Property Office, the disclosure of which is incorporated herein in its entirety by reference.

### BACKGROUND

### 1. Technical Field

The present disclosure relates to an RF canceller and a communication device including the same, and more particularly, to an RF canceller capable of effectively canceling self-interference in in-band full-duplex communication with a limited number of taps, and a communication device including the same.

### 2. Description of the Related Art

Circuits for controlling network delay have been widely used in in-band full-duplex radio (FDR) systems to address radio frequency congestion. Since FDR systems can achieve twice the spectral efficiency compared to conventional time-division duplex systems, they are attracting significant attention for use in 6G.

However, in an FDR system, a self-interference (SI) signal, which is generated by the system's own transmission signal and appears as noise in the receive circuitry, must be removed in order to realize such a system. In particular, the receive circuitry of an FDR system must be capable of suppressing the self-interference signal to a level below the noise floor. However, it is known that the self-interference signal is typically received in the receive circuitry as a signal approximately 110 dB stronger than the noise floor. Thus, it is practically very difficult to cancel such a strong self-interference signal in a single step.

Accordingly, in FDR systems, self-interference cancellation (hereinafter referred to as “SIC”) is generally performed in three stages. In a first stage, passive suppression is performed by increasing the isolation between a transmit antenna and a receive antenna, thereby suppressing the self-interference signal received by the receive antenna. As a result, the receive circuitry receives a residual self-interference signal after passive suppression through the receive antenna. In a second stage, active cancellation is performed by generating a modeled self-interference signal that emulates the residual self-interference signal after passive suppression, and subtracting the modeled self-interference signal from the received residual self-interference signal, thereby removing the residual self-interference signal. In a final, third stage, digital SIC is performed in which a digital signal processing module of the receiver removes, through digital signal processing, a subtracted residual self-interference signal that remains even after active cancellation.

In systems such as WiFi or mobile communication, passive suppression typically removes approximately 30 dB of self-interference, and active cancellation removes an additional 30 dB, while the remaining self-interference is eliminated by digital SIC. That is, approximately 60 dB of SIC is performed in the RF front end, and the digital signal processing module performs SIC on the remaining subtracted residual self-interference signal. The digital signal processing module is theoretically capable of performing digital SIC to a level exceeding 60 dB.

Meanwhile, for active cancellation, the receive circuitry is provided with an RF canceller, which is a circuit configured to generate a modeled self-interference signal that emulates the residual self-interference signal obtained after passive suppression. The RF canceller is generally composed of a plurality of taps that independently generate signals having designated waveforms in order to generate the modeled self-interference signal. In order to generate the modeled self-interference signal to closely resemble the residual self-interference signal, conventional designs have included four or more taps, resulting in increased design and manufacturing costs. Furthermore, as the number of taps increases, the mutual interference among the signals generated at the respective taps makes it difficult to accurately generate the required modeled self-interference signal.

### SUMMARY OF THE INVENTION

An object of the present disclosure is to provide an RF canceller, and a communication device including the same, capable of effectively generating a modeled self-interference signal that is highly similar to a passively suppressed self-interference signal while suppressing the influence of mutual interference among tap signals, even with a reduced number of tap circuits.

Another object of the present disclosure is to provide an RF canceller, and a communication device including the same, capable of simplifying the configuration of a plurality of tap circuits by commonly delaying tap signals respectively generated from the plurality of tap circuits by a reference delay time corresponding to a dominant path using a group delay unit.

According to an embodiment of the present disclosure, an RF canceller comprises: a distribution delay circuit configured to receive a divided transmission signal obtained by dividing a transmission signal transmitted to a transmit antenna, and to re-distribute and delay the divided transmission signal to generate a plurality of distribution signals having fixed delay time differences with respect to one another; a plurality of tap circuits configured to receive one of the plurality of distribution signals and to attenuate and adjust a phase thereof to generate tap signals; a combining circuit configured to receive and combine the plurality of tap signals generated from the plurality of tap circuits to obtain a combined tap signal; and a group delay unit configured to receive the combined tap signal and to apply group delay thereto to generate a modeled self-interference signal.

The group delay unit may apply group delay to the combined tap signal by a reference delay time corresponding to a dominant path between the transmit antenna and the receive antenna, which is pre-measured.

The reference delay time may be determined by converting a received signal applied through the receive antenna into magnitude and phase signals in a frequency domain through Fourier transformation, zero-padding signals in frequency bands other than a designated target band in the magnitude and phase signals in the frequency domain, converting the zero-padded magnitude and phase signals back into a time-domain target-band signal through inverse Fourier transformation, and identifying a time point having the strongest intensity in the target-band signal.

Each of the plurality of taps may generate a tap signal having a waveform that tracks a waveform of a residual self-interference signal transmitted from the transmit antenna and received through the receive antenna, by attenuating and adjusting a phase of the applied distribution signal.

A first tap among the plurality of taps may generate a first tap signal having a maximum intensity equal to an intensity of the residual self-interference signal at the reference delay time corresponding to a dominant path between the transmit antenna and the receive antenna.

Each of the remaining taps among the plurality of taps may generate a tap signal having a maximum intensity equal to an intensity of the residual self-interference signal at a tap unit time interval, which is set to be equal to or less than a reciprocal of a target bandwidth from the reference delay time.

The distribution delay circuit may include a plurality of power dividers and a plurality of delay circuits alternately connected in series, wherein a first power divider among the plurality of power dividers may distribute the divided transmission signal to a first tap circuit among the plurality of tap circuits and to a first delay circuit, and the remaining power dividers may re-distribute a distribution signal delayed by a previously arranged delay circuit and apply the re-distributed signal to a corresponding tap circuit and to a next-arranged delay circuit.

The delay circuit may delay a transmitted signal by a tap unit time calculated as a reciprocal of a target bandwidth and output the delayed signal.

The delay circuit may delay a transmitted signal by one-half of a tap unit time, which is set to be equal to or less than a reciprocal of a target bandwidth, and output the delayed signal.

The combining circuit may include a plurality of output delay circuits configured to receive a tap signal generated from one of the plurality of tap circuits and delay the tap signal by one-half of the tap unit time, and a combiner configured to combine the plurality of tap signals delayed by the plurality of output delay circuits to generate the combined tap signal.

According to another embodiment of the present disclosure, a communication device includes: a transmission circuit configured to generate a transmission signal and to transmit, through a transmit antenna, one of divided transmission signals obtained by distributing the transmission signal; an RF canceller configured to receive the remaining divided transmission signals and to generate a modeled self-interference signal that emulates a residual self-interference signal received through a receive antenna based on the divided transmission signals transmitted from the transmit antenna; and a receive circuit configured to receive the residual self-interference signal and the modeled self-interference signal, subtract the modeled self-interference signal from the residual self-interference signal to obtain a subtracted residual self-interference signal, and remove the subtracted residual self-interference signal through digital signal processing, wherein the RF canceller includes a distribution delay circuit configured to receive the divided transmission signals and to re-distribute and delay the divided transmission signals to generate a plurality of distribution signals having fixed delay time differences with respect to one another, a plurality of tap circuits configured to receive one of the plurality of distribution signals and to attenuate and adjust a phase thereof to generate tap signals, a combining circuit configured to receive and combine the plurality of tap signals generated from the plurality of tap circuits to obtain a combined tap signal, and a group delay unit configured to receive the combined tap signal and apply group delay thereto to generate the modeled self-interference signal.

The RF canceller according to the present disclosure, and the communication device including the same, can simplify the configuration of tap circuits by commonly delaying tap signals respectively generated from a plurality of tap circuits by a reference delay time corresponding to a dominant path using a group delay unit, thereby suppressing the influence caused by mutual interference among the tap signals. Accordingly, the modeled self-interference signal can be generated to be highly similar to the passively suppressed residual self-interference signal even with a reduced number of tap circuits. Therefore, the system can be manufactured at a low cost.

### BRIEF DESCRIPTION OF THE DRAWINGS

FIG. 1 is a schematic diagram illustrating the configuration of an RF canceller according to an embodiment of the present disclosure and an operation of a communication device including the same.

FIG. 2 illustrates an example of a residual self-interference signal and a plurality of tap signals generated from a plurality of taps.

FIG. 3 illustrates a modeled self-interference signal obtained by cumulatively subtracting the plurality of tap signals from the residual self-interference signal of FIG. 2.

FIG. 4 is a schematic diagram illustrating a technique for obtaining a reference delay time.

FIG. 5 illustrates a configuration of an RF canceller according to another embodiment of the present disclosure.

### DETAILED DESCRIPTION OF THE INVENTION

Hereinafter, specific embodiments of the present disclosure will be described with reference to the drawings. The following detailed description is provided to help with comprehensive understanding of a method, a device, and/or a system described in this specification. However, this is only an example, and the present invention is not limited thereto.

In describing embodiments of the present disclosure, when it is determined that detailed description of well-known technologies related to the present invention may unnecessarily obscure the gist of embodiments, the detailed description will be omitted. Terms to be described below are terms defined in consideration of functions in the present invention, and may vary depending on the intention, practice, or the like of a user or operator. Therefore, the terms should be defined on the basis of the overall content of this specification. Terms used in the detailed description are only used to describe embodiments and should not be construed as limiting. Unless otherwise clearly specified, a singular expression includes the plural meaning. In this description, an expression such as “include” or “have” is intended to indicate certain features, numerals, steps, operations, elements, or some or combinations thereof, and should not be construed as excluding the presence or possibility of one or more other features, numerals, steps, operations, elements, or some or combinations thereof. Also, the terms “unit,” “device,” “module,” “block,” and the like described in this specification refer to units for processing at least one function or operation, which may be implemented by hardware, software, or a combination of hardware and software.

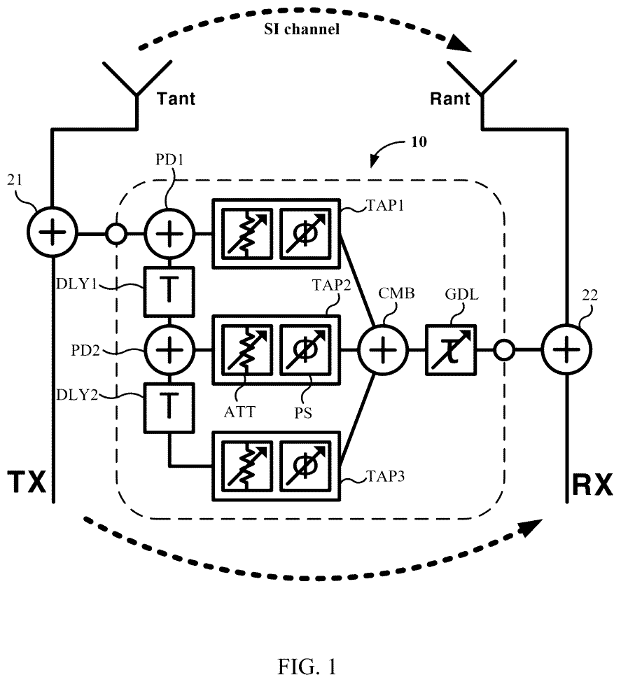

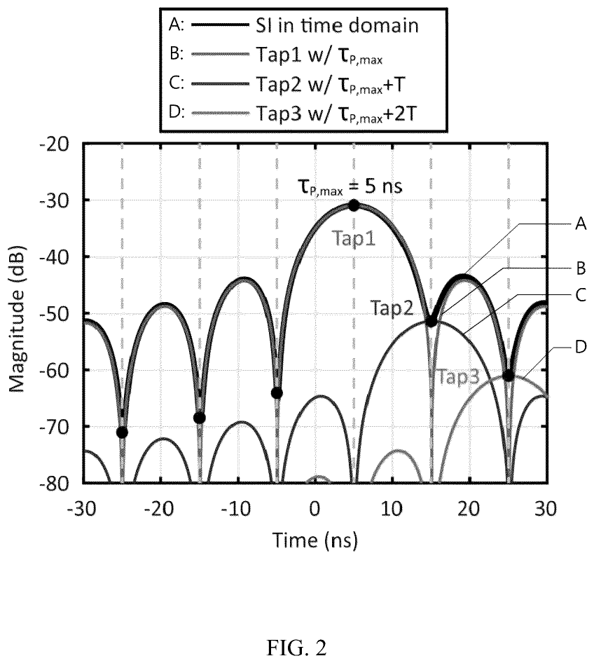

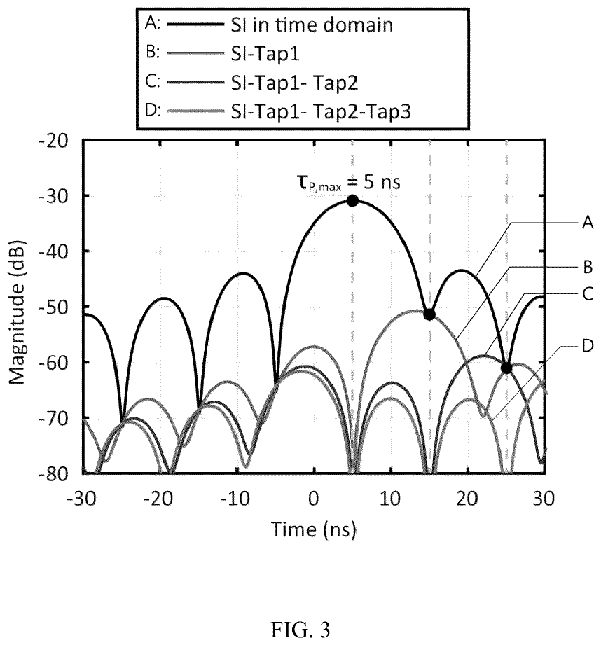

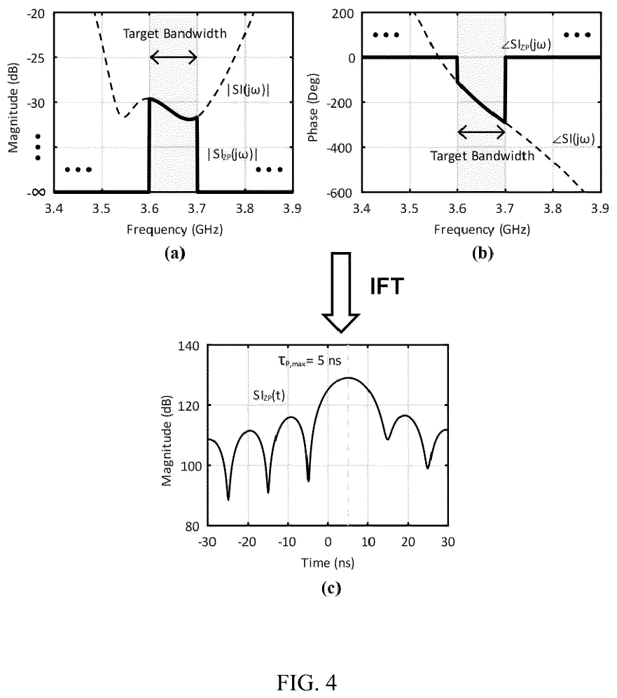

FIG. 1 is a schematic diagram illustrating the configuration of an RF canceller according to an embodiment of the present disclosure and an operation of a communication device including the same, FIG. 2 illustrates an example of a residual self-interference signal and a plurality of tap signals generated from a plurality of taps, and FIG. 3 illustrates a modeled self-interference signal obtained by cumulatively subtracting the plurality of tap signals from the residual self-interference signal of FIG. 2. In addition, FIG. 4 is a diagram illustrating a technique for obtaining a reference delay time.

In one embodiment, the RF canceller 10 may be provided in a communication device of an FDR system. A transmitter splitter 21 of the communication device may split a transmit signal TX transmitted from a transmission circuit (not shown) and transmit the split transmit signal to a transmit antenna Tant and to the RF canceller 10. The transmit antenna Tant radiates the transmitted split transmit signal and transmits it to another communication device. Since the FDR system uses the same frequency band for both transmission and reception, the radiated split transmit signal is also transmitted to a receive antenna Rant of the same communication device through an SI (Self-Interference) channel. As described above, a residual self-interference signal suppressed by passive suppression due to the isolation between the transmit antenna Tant and the receive antenna Rant is received at the receive antenna Rant and is provided to a receive combiner 22. In one example, the residual self-interference signal may be received as a waveform indicated by A in FIGS. 2 and 3. FIGS. 2 and 3 illustrate an example of a residual self-interference signal observed when the transmit antenna Tant and the receive antenna Rant of the FDR system are designed to perform communication in a frequency band of 3.6 to 3.7 GHz, with a target bandwidth (BW) of 100 MHz.

The RF canceller 10 receives the split transmit signal provided from the transmitter splitter 21, generates a modeled self-interference signal that emulates the residual self-interference signal, and transmits the generated modeled self-interference signal to the receive combiner 22.

The receive combiner 22 subtracts the modeled self-interference signal generated by the RF canceller 10 from the residual self-interference signal transmitted through the receive antenna Rant, and provides the resulting subtracted residual interference signal to a digital signal processing module (not shown). The digital signal processing module subsequently removes the subtracted residual self-interference signal by digital signal processing.

Since the receive combiner 22 removes the self-interference by subtracting the modeled self-interference signal from the residual self-interference signal, the RF canceller 10 achieves improved self-interference cancellation performance as the modeled self-interference signal is generated to more closely resemble the residual self-interference signal.

Referring to FIG. 1, the RF canceller 10 according to an embodiment includes a distribution delay circuit, a plurality of tap circuits TAP1 to TAP3, a combiner CMB, and a group delay line GDL.

The distribution delay circuit includes a plurality of power dividers PD1 and PD2 and a plurality of delay circuits DLY1 and DLY2 alternately connected in series. The plurality of power dividers PD1 and PD2 respectively divide an applied signal to obtain two distributed signals, and transmit the obtained two distributed signals to one of the plurality of tap circuits TAP1 to TAP3 connected thereto and to a subsequently arranged circuit. Among the plurality of power dividers PD1 and PD2, the first power divider PD1 receives the distributed transmit signal transmitted from the transmitter splitter 21, distributes the received signal, and transmits the two resulting distributed signals to the first tap circuit TAP1 among the plurality of tap circuits TAP1 to TAP3 and to the first delay circuit DLY1 arranged next. The remaining power divider PD2, other than the first power divider PD1, redistributes the distributed signal that has been delayed and transmitted from the previously arranged delay circuit DLY1, and transmits the redistributed signals to the second tap circuit TAP2 and to the second delay circuit DLY2 arranged subsequently. Since the power dividers PD1 and PD2 distribute the input signal power to generate two distributed signals, each distributed signal has a lower power than the input signal, and may have, for example, one-half of the power of the input signal.

The plurality of delay circuits DLY1 and DLY2 receive the distributed signal transmitted from a previously arranged one of the plurality of power dividers PD1 and PD2, delay the applied distributed signal by a designated fixed tap unit time, and transmit the delayed distributed signal to the subsequently arranged divider. However, the last delay circuit DLY2 arranged in the distribution delay circuit directly transmits the delayed distributed signal to the last tap circuit TAP3 among the plurality of tap circuits TAP1 to TAP3. Accordingly, the distribution delay circuit may include a number of power dividers PD1 and PD2 and delay circuits DLY1 and DLY2 that is smaller by one than the number of tap circuits (TAP1 to TAP3).

Here, each of the plurality of delay circuits DLY1 and DLY2 may delay an applied signal by a tap unit time (T=1/BW) calculated as the reciprocal of the target bandwidth BW. As described above, when the target bandwidth BW is set to 100 MHz, the tap unit time T calculated as the reciprocal of the target bandwidth BW may be 10 ns (= 1/100 MHz), which may also be regarded as a sampling period corresponding to the Nyquist rate.

In this case, as illustrated in FIGS. 2 and 3, the residual self-interference signal exhibits its strongest magnitude at the reference delay time τ_{P.max}x corresponding to the dominant path, and shows a pattern in which the magnitude repeatedly increases and decreases at intervals of the tap unit time T on both sides of the reference delay time (τ_{P.max}).

Meanwhile, the plurality of tap circuits TAP1 to TAP3 respectively receive distribution signals that are delayed by different amounts so as to have time differences of one tap unit time T, and generate tap signals having waveforms that track the waveform of the residual self-interference signal by adjusting the distribution signals—each applied with different time delays—to have waveforms similar to the residual self-interference signal. As shown in FIG. 2, the waveforms indicated by B, C, and D correspond to the tap signals respectively generated by the three tap circuits TAP1 to TAP3, and it can be seen that these tap signals have waveforms as similar as possible to the residual self-interference signal indicated by A. Each of the plurality of tap circuits TAP1 to TAP3 may include an attenuator ATT and a phase shifter PS, and may generate a tap signal by adjusting the magnitude and phase of the applied distribution signal. The waveform of the residual self-interference signal may be measured and identified in advance, and the attenuators ATT and phase shifters PS of the plurality of tap circuits TAP1 to TAP3 may be pre-adjusted such that the input distribution signals produce tap signals whose waveforms closely follow the previously identified residual self-interference signal.

The combiner CMB receives and combines the tap signals respectively generated by the plurality of tap circuits TAP1 to TAP3, thereby obtaining a combined tap signal.

The group delay line GDL group-delays the combined tap signal, which includes the plurality of tap signals, by an amount corresponding to the reference delay time τ_{P,max} max according to the dominant path between the transmit antenna Tant and the receive antenna Rant, thereby generating a modeled self-interference signal. Here, the reference delay time τ_{P,max} max may be previously obtained through measurement. For example, in order to obtain the reference delay time τ_{P,max}, the residual self-interference signal received through the receive antenna Rant is first subjected to a Fourier transform, thereby acquiring magnitude and phase signals in the frequency domain, as illustrated by the dotted graphs in (a) and (b) of FIG. 4. Then, in each of the transformed magnitude and phase signals, the frequency components outside the designated target bandwidth are zero-padded, resulting in the waveforms shown as the solid lines in (a) and (b) of FIG. 4. Subsequently, the zero-padded magnitude and phase signals are subjected to an inverse Fourier transform to obtain the target-bandwidth signal in the time domain, as shown in (c) of FIG. 4. The time point having the strongest amplitude in the re-transformed target-bandwidth signal is then identified, and the identified time point is acquired as the reference delay time τ_{P,max}. In this example, the reference delay τ_{P,max} is obtained as 5 ns.

Since the group delay line GDL generates the modeled self-interference signal by group-delaying the combined tap signal, which includes the plurality of tap signals, by the reference delay time τ_{P,max}, each of the plurality of tap circuits TAP1 to TAP3 only needs to generate its tap signal without considering the reference delay time τ_{P,max}. In addition, each of the plurality of tap circuits TAP1 to TAP3 receives a distributed signal that has already been delayed in multiples of the tap unit time T by the plurality of delay circuits DLY1 and DLY2. Accordingly, because the final delay time required for each tap signal generated by the plurality of tap circuits TAP1 to TAP3 is separately adjusted by the group delay line GDL and the plurality of delay circuits DLY1 and DLY2, each of the plurality of tap circuits TAP1 to TAP3 may generate its tap signal without considering any delay time, and may instead adjust only the waveform of the generated tap signal—using the attenuator ATT and the phase shifter PS—to resemble the waveform of the residual self-interference signal.

In this case, the first tap circuit TAP1 among the plurality of tap circuits TAP1 to TAP3 generates a tap signal with a magnitude as close to the residual self-interference signal as possible, as shown in the waveform B in FIG. 1. In particular, the first tap circuit generates a first tap signal having a peak magnitude equal to the magnitude of the residual self-interference signal at the reference delay time τ_{P.max}, at which the residual self-interference signal exhibits its strongest magnitude.

The second tap circuit TAP2 generates a tap signal having a peak magnitude identical to that of the residual self-interference signal at a time delayed by the tap-unit time T from the reference delay time τ_{P,max} (i.e., a_{P,max}+T). Although the first tap signal can be generated to be very similar to the residual self-interference signal, that is, the first tap signal produced by a single first tap circuit TAP1 inevitably exhibits a difference from the residual self-interference signal. In particular, as shown in FIG. 2, while the residual self-interference signal has a magnitude of −50 dB at τ_{P,max}+T, the first tap signal generated by the first tap circuit TAP1 has a magnitude lower than −80 dB. Likewise, while the residual self-interference signal has a magnitude of −62 dB at τ_{P,max}+2T, the first tap signal has a magnitude lower than −80 dB. That is, a large discrepancy occurs between the residual self-interference signal and the first tap signal at intervals of the tap-unit time T.

As a result, as shown in FIG. 3, the magnitude of the signal indicated by B, which is obtained by subtracting the first tap signal from the residual self-interference signal, increases and decreases at intervals of (τ_{P.max}±nT, where n is a natural number).

Accordingly, the second tap circuit TAP2 generates a tap signal having the same peak magnitude as that of the residual self-interference signal at (τ_{P.max}+T), thereby enabling the modeled self-interference signal to be almost completely removed at (τ_{P.max}+T), as illustrated by the waveform C in FIG. 3. Similarly, the third tap circuit TAP3 generates a tap signal having the same peak magnitude as that of the residual self-interference signal at (τ_{P.max}+2T), thereby enabling the modeled self-interference signal to be almost completely removed at (τ_{P.max}+2T), as illustrated by the waveform D in FIG.

That is, each of the plurality of tap circuits TAP1 to TAP3 generates a tap signal such that the strongest signal component among the remaining signal components, which remains after subtracting the tap signal generated by the previous tap circuit from the residual self-interference signal, is removed.

At this time, since the tap signals generated by the plurality of tap circuits TAP1 to TAP3 are formed as waveforms whose magnitudes significantly decrease at intervals of the tap unit time T, each tap signal scarcely affects the other tap signals at the time point where it is intended to remove a corresponding component of the residual self-interference signal. That is, mutual interference among the tap signals hardly occurs.

In conventional RF cancellers, because no group delay line is employed, each of the plurality of tap circuits had to include its own delay circuit. If individual delay circuits are not provided for each of the plurality of tap circuits, the tap signals generated by the respective tap circuits interfere with one another. For example, even when the first tap circuit TAP1 generates a first tap signal to cancel the residual self-interference signal at τ_{P.max}, the residual self-interference signal may fail to be effectively cancelled due to signal components of the second tap signal generated by the second tap circuit TAP2. In contrast, in the RF canceller 10 according to an embodiment, the group delay line GDL commonly delays the plurality of tap signals, and the delay intervals among the plurality of tap signals are equalized by the plurality of delay circuits DLY1 and DLY2. As a result, mutual interference among the plurality of tap signals can be minimized. That is, each tap circuit may be configured to generate a tap signal having the same magnitude as the residual self-interference signal at tap unit time T intervals (τ_{P.max}+nT), based on the reference delay time τ_{P.max} and without considering tap signals generated by other tap circuits.

In this manner, when each of the plurality of tap circuits TAP1 to TAP3 generates a tap signal having the same magnitude as that of the residual self-interference signal at intervals (τ_{P.max}+nT) of the tap unit time (T), based on the reference delay time τ_{P.max}, the strongest remaining signal component in the remaining subtracted residual self-interference signal—after the previous tap signal has been subtracted from the residual self-interference signal—is sequentially removed. Accordingly, the RF canceller 10 can effectively cancel the residual self-interference signal even with a small number of tap circuits. Thus, in the present example, the RF canceller 10 is illustrated as including only three tap circuits TAP1 to TAP3. Furthermore, since the delay time required for each tap signal generated by the tap circuits TAP1 to TAP3 is adjusted by the group delay line GDL and the delay circuits DLY1 and DLY2, and mutual interference between tap signals does not need to be considered, each tap circuit TAP1 to TAP3 can be implemented with a simple configuration including only an attenuator ATT and a phase shifter PS.

As a result, the RF canceller according to an embodiment can delay, in common, the tap signals respectively generated by the plurality of tap circuits by the reference delay time corresponding to the dominant path using the group delay line, thereby suppressing influences caused by mutual interference among the tap signals and simplifying the configuration of the tap circuits. In addition, even with a small number of tap circuits, it is possible to effectively generate a modeled self-interference signal that is highly similar to the passively suppressed residual self-interference signal. Therefore, the RF canceller can be manufactured at low cost.

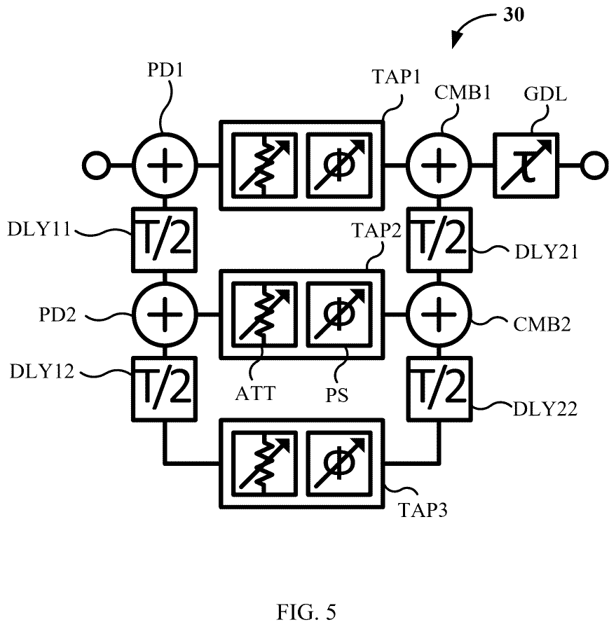

FIG. 5 illustrates a configuration of an RF canceller according to another embodiment of the present disclosure.

FIG. 5 likewise illustrates that the RF canceller 30 includes a distribution delay circuit, a plurality of tap circuits TAP1 to TAP3, a combining circuit, and a group delay line GDL.

Here, as in the distribution delay circuit of FIG. 1, the distribution delay circuit includes a plurality of power dividers PD1 and PD2 and a plurality of first delay circuits DLY11 and DLY12 alternately connected in series. The plurality of power dividers PD1 and PD2 each divide an applied signal to obtain two distributed signals, and the plurality of first delay circuits DLY11 and DLY12 each receive one of the two distributed signals divided by the preceding power divider PD1 and PD2, delay the received distributed signal, and output the delayed signal. However, in FIG. 5, each of the plurality of first delay circuits DLY11 and DLY12 delays the input signal by T/2, which is one half of the tap unit time T, and outputs the delayed signal. Furthermore, as in FIG. 1, each of the plurality of tap circuits TAP1 to TAP3 adjusts the applied distributed signal such that the adjusted signal has a waveform that follows the residual self-interference signal, and outputs a corresponding tap signal.

However, in the RF canceller 30 of FIG. 1, only a single combiner CMB is provided, and the tap signals generated by the plurality of tap circuits TAP1 to TAP3 are directly combined to generate the combined tap signal. In contrast, in the RF canceller 30 of FIG. 5, since each of the plurality of first delay circuits DLY11 and DLY12 in the distribution delay circuit outputs the applied signal delayed by T/2, the time difference between the generated tap signals is also T/2. Accordingly, the combining circuit of the RF canceller 30 in FIG. 5 includes a plurality of combiners CMB1 and CMB2 and a plurality of second delay circuits DLY21 and DLY22 alternately connected in series. Each of the plurality of second delay circuits DLY21 and DLY22, similar to the plurality of first delay circuits DLY11 and DLY12, outputs the applied signal delayed by T/2, and each of the plurality of combiners CMB1 and CMB2 combines a tap signal applied from a corresponding tap circuit with a signal delayed through a second delay circuit DLY21 and DLY22 and outputs the result. That is, the combining circuit receives the tap signals generated from the respective tap circuits TAP1 to TAP3, delay-combines them, and generates the combined tap signal. Therefore, the tap signals included in the final combined tap signal output from the first combiner CMB1 have a delay time difference of one tap unit time T, as in the RF canceller 30 of FIG. 1.

The group delay line GDL generates a modeled self-interference signal by applying a group delay corresponding to the reference delay time τ_{P.max} to the combined tap signal finally obtained from the first combiner CMB1.

The RF canceller 30 of FIG. 5 basically performs the same operation as the RF canceller 10 of FIG. 1. However, whereas in the RF canceller 10 of FIG. 1 the distribution delay circuit provides a distribution signal delayed by a tap unit time T to the plurality of tap circuits TAP1 to TAP3, the RF canceller 30 of FIG. 5 divides the delay by T/2 for both the distribution signal input to the plurality of tap circuits TAP1 to TAP3 and the tap signals output from the plurality of tap circuits TAP1 to TAP3.

In the foregoing description, the plurality of delay circuits DLY1 and DLY2 were described as outputting the input signals after delaying them by a tap unit time (T=1/BW) calculated as the reciprocal of the target bandwidth BW, and the plurality of first delay circuits DLY11 and DLY12 and the plurality of second delay circuits DLY21 and DLY22 were described as outputting the signals after delaying them by one half of the tap unit time T. The plurality of tap signals included in the final combined tap signal were also described as having delay time differences of the tap unit time (T). However, this is a value set based on the Nyquist rate, which is the minimum sampling rate that prevents aliasing, and aliasing does not occur even when the sampling rate is equal to or greater than the target bandwidth BW.

Accordingly, the tap unit time T delayed by each of the plurality of delay circuits DLY1 and DLY2 may be set to be equal to or less than the reciprocal of the target bandwidth BW, i.e., T≤1/BW. In addition, the plurality of first delay circuits DLY11 and DLY12 and the plurality of second delay circuits DLY21 and DLY22 may be configured to delay the signals by one half of the tap unit time T, where the tap unit time T is set to be equal to or less than the reciprocal of the target bandwidth BW, i.e., T≤1/BW.

However, when the tap unit time T is set to a value smaller than the reciprocal of the target bandwidth BW, the number of tap circuits TAP1 to TAP3 included in the RF canceller 30 must be increased, and accordingly, the numbers of power dividers and delay circuits may also increase.

In the illustrated embodiment, respective configurations may have different functions and capabilities in addition to those described above, and may include additional configurations in addition to those described above. In addition, in an embodiment, each configuration may be implemented using one or more physically separated devices, or may be implemented by one or more processors or a combination of one or more processors and software, and may not be clearly distinguished in specific operations unlike the illustrated example.

In addition, the RF canceller and the communication device including the same illustrated in FIG. 1 may be implemented in a logic circuit by hardware, firm ware, software, or a combination thereof or may be implemented using a general purpose or special purpose computer. The apparatus may be implemented using hardwired device, field programmable gate array (FPGA) or application specific integrated circuit (ASIC). The apparatus may also be implemented by a system on chip (SoC) including one or more processors and a controller.

In addition, the RF canceller and the communication device including the same may be mounted in a computing device or server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

The present disclosure has been described in detail through a representative embodiment, but those of ordinary skill in the art to which the art pertains will appreciate that various modifications and other equivalent embodiments are possible. Therefore, the true technical protection scope of the present disclosure should be defined by the claims.

What is claimed is:

1. An RF canceller comprising:
a distribution delay circuit configured to receive a divided transmission signal obtained by dividing a transmission signal transmitted to a transmit antenna, and to re-distribute and delay the divided transmission signal to generate a plurality of distribution signals having fixed delay time differences with respect to one another;
a plurality of tap circuits configured to receive one of the plurality of distribution signals and to attenuate and adjust a phase thereof to generate a plurality of tap signals;
a combining circuit configured to receive and combine the plurality of tap signals generated from the plurality of tap circuits to obtain a combined tap signal; and
a group delay unit configured to receive the combined tap signal and to apply group delay thereto to generate a modeled self-interference signal.

2. The RF canceller according to claim 1,
wherein the group delay unit applies group delay to the combined tap signal by a reference delay time corresponding to a dominant path between the transmit antenna and a receive antenna, which is pre-measured.

3. The RF canceller according to claim 2,
wherein the reference delay time is determined by
converting a received signal applied through the receive antenna into magnitude and phase signals in a frequency domain through Fourier transformation,
zero-padding signals in frequency bands other than a designated target band in the magnitude and phase signals in the frequency domain,
converting the zero-padded magnitude and phase signals back into a time-domain target-band signal through inverse Fourier transformation, and identifying a time point having the strongest intensity in the target-band signal.

4. The RF canceller according to claim 1,
wherein each of the plurality of tap circuits generates a tap signal having a waveform that tracks a waveform of a residual self-interference signal transmitted from the transmit antenna and received through a receive antenna, by attenuating and adjusting a phase of the applied distribution signal.

5. The RF canceller according to claim 4,
wherein a first tap among the plurality of tap circuits generates a first tap signal having a maximum intensity equal to an intensity of the residual self-interference signal at a reference delay time corresponding to a dominant path between the transmit antenna and the receive antenna.

6. The RF canceller according to claim 5,
wherein each of the remaining tap circuits among the plurality of tap circuits generates a tap signal having a maximum intensity equal to an intensity of the residual self-interference signal at a tap unit time interval, which is set to be equal to or less than a reciprocal of a target bandwidth from the reference delay time.

7. The RF canceller according to claim 1,
wherein the distribution delay circuit includes a plurality of power dividers and a plurality of delay circuits alternately connected in series,
wherein a first power divider among the plurality of power dividers distributes the divided transmission signal to a first tap circuit among the plurality of tap circuits and to a first delay circuit, and
the remaining power dividers re-distribute a distribution signal delayed by a previously arranged delay circuit and applies the re-distributed signal to a corresponding tap circuit and to a next-arranged delay circuit.

8. The RF canceller according to claim 7,
wherein the delay circuit delays a transmitted signal by a tap unit time, which is set to be equal to or less than a reciprocal of a target bandwidth, and output the delayed signal.

9. The RF canceller according to claim 7,
wherein the delay circuit delays a transmitted signal by one-half of a tap unit time, which is set to be equal to or less than a reciprocal of a target bandwidth, and output the delayed signal.

10. The RF canceller according to claim 9,
wherein the combining circuit includes
a plurality of output delay circuits configured to receive a tap signal generated from one of the plurality of tap circuits and delay the tap signal by one-half of the tap unit time, and
a combiner configured to combine the plurality of tap signals delayed by the plurality of output delay circuits to generate the combined tap signal.

11. A communication device comprising:
a transmission circuit configured to generate a transmission signal and to transmit, through a transmit antenna, one of divided transmission signals obtained by distributing the transmission signal;
an RF canceller configured to receive the remaining divided transmission signals and to generate a modeled self-interference signal that emulates a residual self-interference signal received through a receive antenna based on the divided transmission signals transmitted from the transmit antenna; and
a receive circuit configured to receive the residual self-interference signal and the modeled self-interference signal, subtract the modeled self-interference signal from the residual self-interference signal to obtain a subtracted residual self-interference signal, and remove the subtracted residual self-interference signal through digital signal processing,
wherein the RF canceller includes a distribution delay circuit configured to receive the divided transmission signals and to re-distribute and delay the divided transmission signals to generate a plurality of distribution signals having fixed delay time differences with respect to one another, a plurality of tap circuits configured to receive one of the plurality of distribution signals and to attenuate and adjust a phase thereof to generate a plurality of tap signals, a combining circuit configured to receive and combine the plurality of tap signals generated from the plurality of tap circuits to obtain a combined tap signal, and a group delay unit configured to receive the combined tap signal and apply group delay thereto to generate the modeled self-interference signal.

12. The communication device according to claim 11,
wherein the group delay unit applies group delay to the combined tap signal by a reference delay time corresponding to a dominant path between the transmit antenna and the receive antenna, which is pre-measured.

13. The communication device according to claim 12,
wherein the reference delay time is determined by
converting a received signal applied through the receive antenna into magnitude and phase signals in a frequency domain through a Fourier transformation,
zero-padding signals in frequency bands other than a designated target band in the magnitude and phase signals in the frequency domain,
converting the zero-padded magnitude and phase signals back into a time-domain target-band signal through an inverse Fourier transformation, and identifying a time point having the strongest intensity in the target-band signal.

14. The communication device according to claim 11,
wherein each of the plurality of tap circuits generates a tap signal having a waveform that tracks a waveform of a residual self-interference signal transmitted from the transmit antenna and received through the receive antenna, by attenuating and adjusting a phase of the applied distribution signal.

15. The communication device according to claim 14,
wherein a first tap among the plurality of tap circuits generates a first tap signal having a maximum intensity equal to an intensity of the residual self-interference signal at a reference delay time corresponding to a dominant path between the transmit antenna and the receive antenna.

16. The communication device according to claim 15,
wherein each of the remaining tap circuits among the plurality of tap circuits generates a tap signal having a maximum intensity equal to an intensity of the residual self-interference signal at a tap unit time interval, which is set to be equal to or less than a reciprocal of a target bandwidth from the reference delay time.

17. The communication device according to claim 11,
wherein the distribution delay circuit includes a plurality of power dividers and a plurality of delay circuits alternately connected in series,
wherein a first power divider among the plurality of power dividers distributes the divided transmission signal to a first tap circuit among the plurality of tap circuits and to a first delay circuit, and
the remaining power dividers re-distribute a distribution signal delayed by a previously arranged delay circuit and applies the re-distributed signal to a corresponding tap circuit and to a next-arranged delay circuit.

18. The communication device according to claim 17,
wherein the delay circuit delays a transmitted signal by a tap unit time, which is set to be equal to or less than a reciprocal of a target bandwidth, and output the delayed signal.

19. The communication device according to claim 17,
wherein the delay circuit delays a transmitted signal by one-half of a tap unit time, which is set to be equal to or less than a reciprocal of a target bandwidth, and output the delayed signal.

20. The communication device according to claim 17,
wherein the combining circuit includes
a plurality of output delay circuits configured to receive a tap signal generated from one of the plurality of tap circuits and delay the tap signal by one-half of a tap unit time, and
a combiner configured to combine the plurality of tap signals delayed by the plurality of output delay circuits to generate the combined tap signal.
